(19) United States
(12) Patent Application Publication
(10) Pub. No.: US 2008/0135595 A1
(43) Pub. Date: Jun. 12, 2008

(54) Toilet Paper Case To Prevent Contamination

(76) Inventor: Shih-Kuo Chang, Tainan (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/555,153

(22) Filed: Oct. 31, 2006

(51) Int. Cl. B26F 3/02

(52) U.S. Cl. 225/39

(57) ABSTRACT

A toilet paper case to prevent contamination includes a case and a cover. The case comprises a housing having an outlet. A block and a shaft spaced from each other are provided at the outlet. The case is provided with a pair of fixtures at opposite sides of the housing. The cover is pivotally connected to the case to cover the housing, and comprises a serrated edge in relation to the outlet. The toilet paper passing through the block and shaft can be torn off with the serrated edge, and the remaining toilet paper will be blocked by the block and the shaft from retracting into the case.

### BACKGROUND OF THE INVENTION

1. Field of the Invention

The present invention relates to a toilet paper case to prevent contamination, in particular to a case having a block and a shaft spaced from each other and provided at an outlet of the case and a cover having a serrated edge to tear down the toilet paper and to prevent the toilet paper from retracting into the case.

2. Description of the Prior Art

A conventional toilet paper case on the market, as shown in FIG. 6, comprises a paper case A having a fixture A1 and a pair of triangle side segments A2. A reel A3 is pivotally connected to the side segments A2. A roll of paper B is sleeved onto the reel A3. A press plate A4 having a serrated edge A5 is provided on the fixture A1.

However, there is no any control device to help the user pick up the paper as needed. The user has to pull the paper from the case with one hand, while the other hand is to press down the press plate A4.

The Prior Art has Some Shortcomings:
1. The press plate is touched by the user's hands after using toilet which may carry unknown germs.
2. The toilet paper will reel back to the case after the user tears off the paper, which is inconvenient for the next user.
3. The toilet paper is mounted in a clockwise direction to be cut by the serrated edge. If the toilet paper is mounted in the opposite direction, the toilet paper will not be cut smoothly

### SUMMARY OF THE INVENTION

According to the present invention, there is provided a toilet paper case comprising a case and a cover. The case comprises a housing having an outlet. A block and a shaft spaced from each other are provided at the outlet. The case is provided with a pair of fixtures at opposite sides of the housing. The cover is pivotally connected to the case to cover the housing, and comprises a serrated edge in relation to the outlet. Each of the fixtures comprises an insert section at one end, and the case is provided with a pair of slots for insertion of the insert section of each fixture. Each of the fixtures comprises a reel section at another end.

It is the primary objective of the present invention to provide a toilet paper case to prevent contamination, which has the block to leave a longer portion of toilet paper outwardly from the case for the user to grasp and to tear off.

It is another objective of the present invention to provide a toilet paper to prevent contamination, which allows people to pick as much paper as they want without touching the paper case.

It is a further objective of the present invention to provide a toilet paper case to prevent contamination, which does not have the restriction of mounting the paper in a clockwise direction or in a counterclockwise direction.

### BRIEF DESCRIPTION OF THE DRAWINGS

FIG. 1 is a perspective of the present invention;

FIG. 2 is a cross-sectional view of the present invention;

FIG. 3 is a side cross-sectional view showing mounting of a paper roll to the present invention;

FIG. 4 is a side cross-sectional view showing how to pull the toilet paper away from the case of the present invention;

FIG. 5 is a side cross-sectional view showing that the toilet paper is mounted in a counterclockwise direction;

FIG. 6 is a side cross-section view of the prior art.

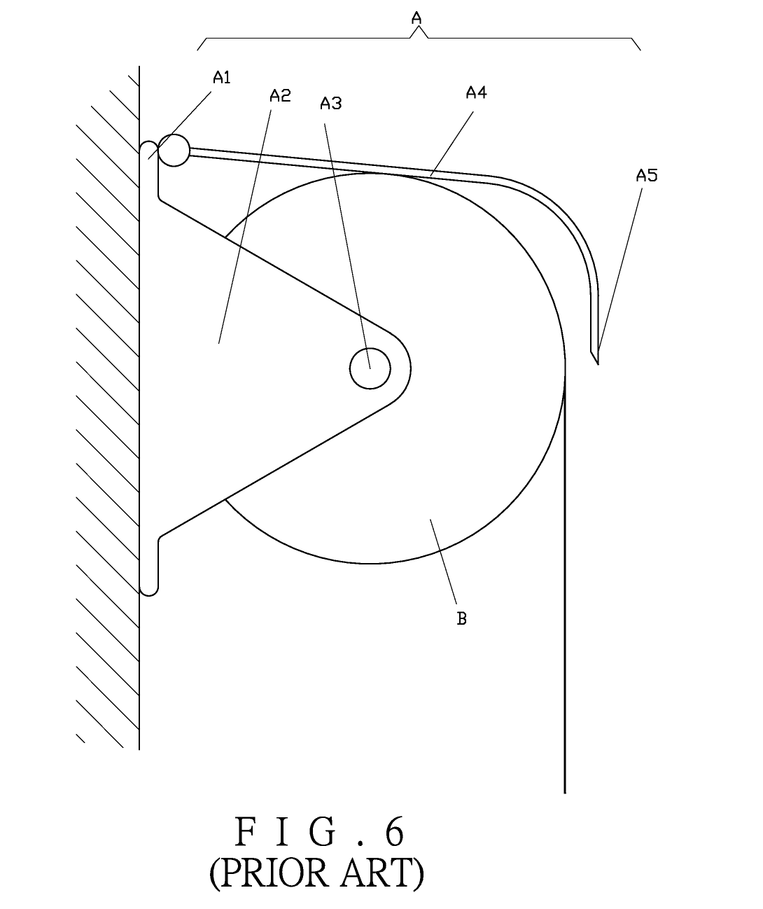

### DETAILED DESCRIPTION OF THE PREFERRED EMBODIMENT

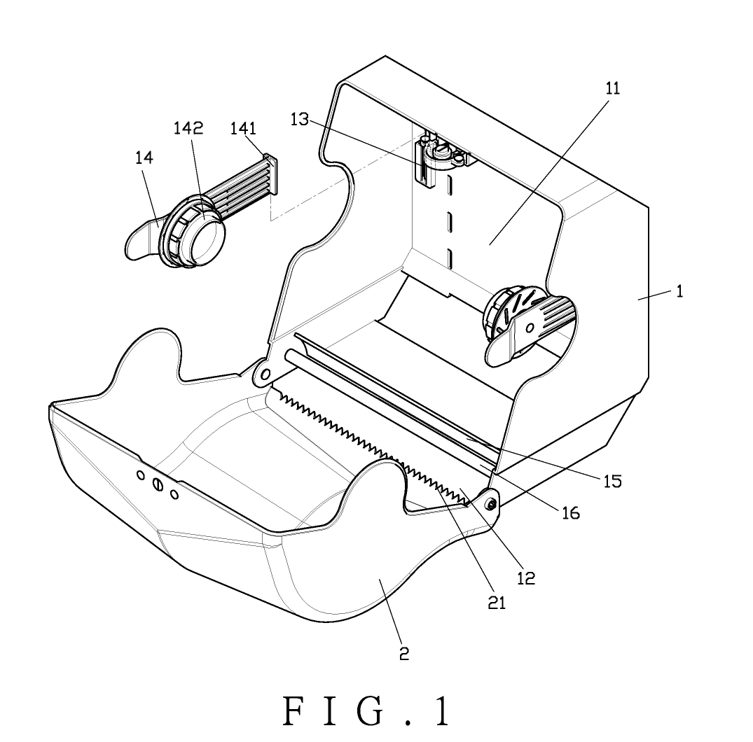

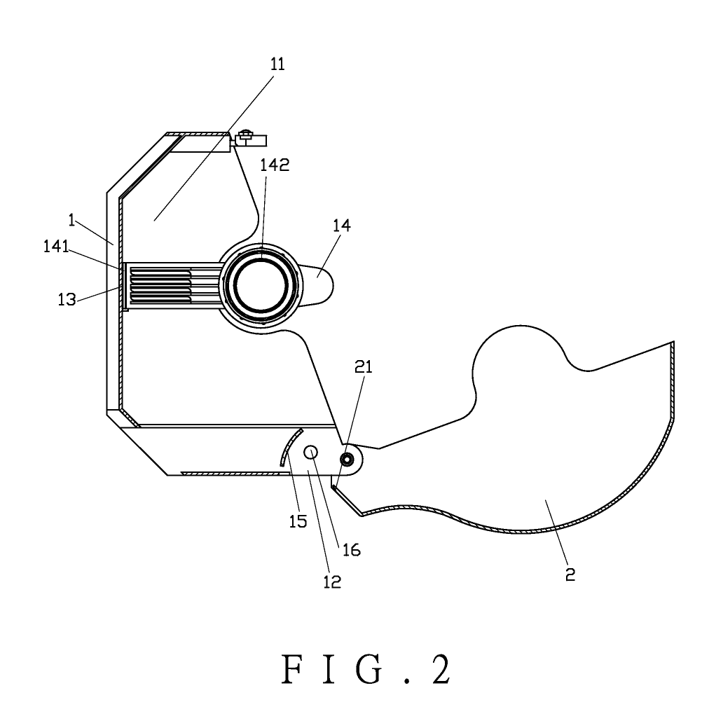

As shown in FIGS. 1 and 2, the present invention comprises a toilet paper case 1 and a cover 2.

The case 1 comprises a housing 11 having an outlet 12 and a pair of slots 13 on respective sides of the inner wall for a pair of fixtures 14 to be secured therein. Each of the fixtures 14 comprises an insert section 141 at one end and a reel section 142 at the opposite end thereof. A block 15 and a shaft 16 spaced from each other are provided at the outlet 12 of the case 1.

The cover 2 is pivotally connected to the case 1 to cover the housing 11, and has a serrated edge 21 in relation to the outlet 12 of the case 1.

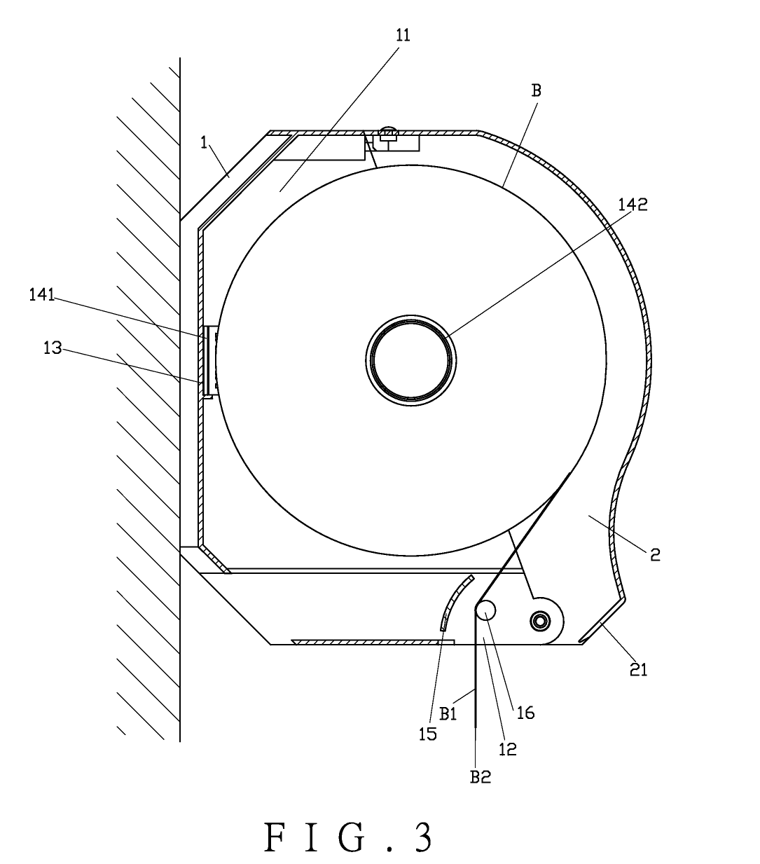

To assemble the present invention, as shown in FIG. 3, the insert sections 141 of the fixtures 14 are inserted into the slots 13 of the case 1. A roll B of toilet paper B1 is inserted on the reel sections 142 of the fixtures 14. A distal end B2 of the toilet paper B1 goes through the outlet 12 of the case 1 between the block 15 and the shaft 16 and leaves a length outwardly from the outlet 12.

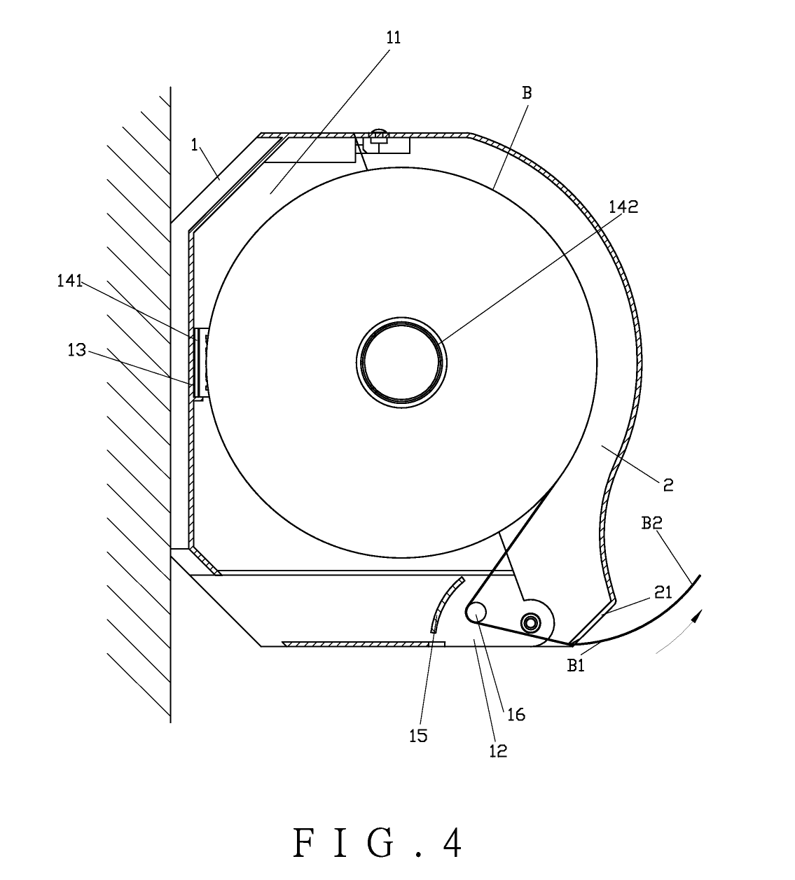

To operate the present invention, as shown in FIG. 4, using a single hand to pull the toilet paper B1 off from the case 1 upwardly, this brings the toilet paper B1 close to the serrated edge 21 of the cover 2. The shaft 16 will produce resistance so that the toilet paper B1 is easy to be torn down in a reasonable length and remains a length out of the outlet 12 for the next user to grasp and to pull the toilet paper B1 for his/her need. The block 15 provides a restriction force so that toilet paper B1 will not retract back into the case 1.

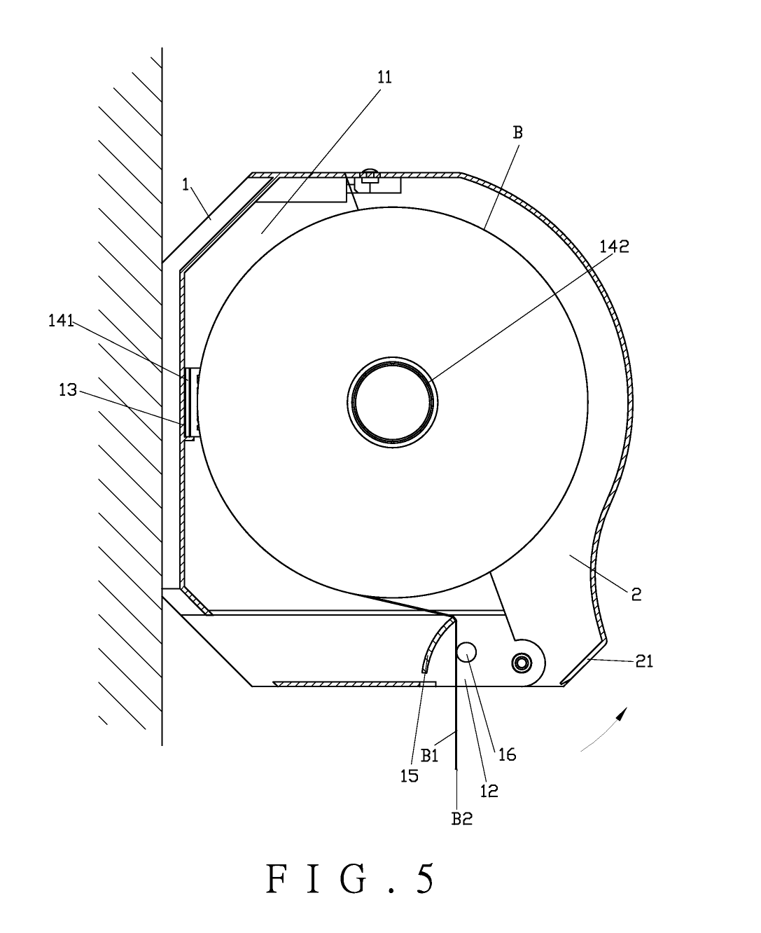

When mounting the roll B into the case 1, the direction of the toilet paper B1 to be mounted is not important, as shown in FIG. 5. Either direction will work. When the toilet paper B1 is mounted in a counterclockwise direction, the distal end B2 of the toilet paper B1 will go through the outlet 12 between the block 15 and the shaft 16. The block 15 and the shaft 16 will leave a portion of the distal end B2 outwardly from the outlet 12.

I claim:

1. A toilet paper case to prevent contamination comprising:
a case comprising a housing having an outlet, a block and a shaft spaced from each other being provided at said outlet, a pair of fixtures being provided at opposite sides of said housing of said case; and
a cover being pivotally connected to said case and comprising a serrated edge in relation to said outlet of said case.

2. The toilet paper case to prevent contamination, as recited in claim 1, wherein each of said fixtures comprises an insert section at one end, and said case is provided with a pair of slots for insertion of said insert section of each said fixture.

3. The toilet paper case to prevent contamination, as recited in claim 1, wherein each of said fixtures comprises a reel section at another end.
